(19) United States
(12) Patent Application Publication
(10) Pub. No.: US 2025/0339821 A1
(43) Pub. Date: Nov. 6, 2025

(54) MEMBRANE-BASED NATURAL GAS SWEETENING UNDER HUMID CONDITIONS

(71) Applicant: Chevron U.S.A. Inc., San Ramon, CA (US)

(72) Inventors: Nitesh Bhuwania, Richmond, CA (US); Daniel Chinn, Danville, CA (US)

(21) Appl. No.: 18/926,115

(22) PCT Filed: May 10, 2023
(86) PCT No.: PCT/US2023/021770

§ 371 Date: Oct. 24, 2024

Related U.S. Application Data
(60) Provisional application No. 63/340,449, filed on May 10, 2022.

(51) Int. Cl. B01D 63/02; B01D 63/10; B01D 69/08

(52) U.S. Cl. CPC B01D 63/02; B01D 63/10; B01D 69/08; B01D 2256/245; B01D 2257/304; B01D 2257/504; B01D 2311/103; B01D 2311/14

(57) ABSTRACT

A process temperature of at least 30° C., and a relative humidity of at least 30%. The natural gas feed stream has a H₂S/CO₂ ratio of 3 or greater. The process includes feeding the natural gas feed stream from the gas liquid separator to a polymeric membrane of a membrane separation system. the polymeric membrane having a H₂S/CH₄ selectivity of at least 10 and CO₂/CH₄ selectivity of at least 5 at the pressure, temperature, and at a relative humidity of the natural gas feed stream.

### FIELD

The present disclosure relates to systems and methods for membrane-based gas separation in oil and gas facilities.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Natural gas is a particularly attractive energy source, due to its low carbon footprint and increased availability in comparison with coal. Methane (CH₄) typically comprises 50%-90% of natural gas; however, undesirable impurities, such as H₂O, CO₂, H₂S, N₂, C₂H₆ etc. are also present in the raw gas. Upgrading produced gas before delivery to the pipeline is required, and carbon dioxide (CO₂) and hydrogen sulfide (H₂S) are priority gases (commonly referred to as “acid gases”) requiring removal. Further, production of fluids from oil and gas reservoirs containing high levels of H₂S provides the additional challenge of significant H₂S separation/removal. There are at least two widely practiced methods of processing natural gas with high H₂S. In one known method, the entire H₂S-containing natural gas stream (also referred to herein as sour gas) is dehydrated, compressed, and reinjected at high pressure in an underground formation. In another known method, the gas is sweetened (reduced in H₂S) in an amine unit using amine scrubbing, followed by dehydration and optionally fractionation to extract propane and butane prior to being sold as sales gas (containing mostly methane, ethane and some nitrogen). Adsorption-based (carbonate, or carbon molecular sieves) processes have also been developed for H₂S removal.

Compared to these conventional processes, membrane-based gas separation is a technology with low capital cost, potentially high energy efficiency, small footprint, modularity, simple operation, and low maintenance, as well as minimal environmental impact. It is well known to use gas separation membranes to remove CO₂ and H₂S from natural gas feed streams. For example, the present inventors have previously demonstrated that membrane separation can be integrated in an oil and gas facility (containing H₂S-natural gas) to debottleneck facilities and improve production. By way of example, patent U.S. Pat. No. 10,363,517 discloses the use of two different types of membranes to treat moisture and perform H₂S removal separately. This process can be applied to many different types of membranes, for example cellulose triacetate (CTA) membranes and rubbery membranes such as block copolymer polyamide/polyether-based membranes. The membranes used can take the form of asymmetric hollow fiber membranes and asymmetric film composite membranes that include a porous layer and a nonporous skin layer.

Selectivity performance (e.g., the selectivity of the membrane for one gas over another) is a critical factor for membranes, and poor membrane performance can result in less than optimal overall gas treatment processes from an economic or performance perspective. In some situations, certain factors are controlled to assist in enhancing membrane selectivity. For instance, in membrane-based natural gas sweetening processes (i.e., H₂S removal process), the natural gas is typically dehydrated using either a glycol based (e.g., triethylene glycol (TEG)) process or solid sorbent-based temperature swing adsorption (TSA) process. This dehydration ‘pre-treatment’ of the feed is generally done upstream of the membranes to mitigate the impact of water, which is generally recognized to reduce the performance of the membrane CO₂ removal for natural gas.

There exists a continuing need for membrane systems and methods providing improved acid gas removal.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one aspect, a process of separating H₂S and CO₂ out of a natural gas feed stream includes flowing the natural gas feed stream out of a gas liquid separator at a pressure of at least 20 bar, a temperature of at least 30° C., and a relative humidity of at least 30%. The natural gas feed stream from the gas liquid separator has a H₂S/CO₂ ratio of 3 or greater. The process also includes feeding the natural gas feed stream from the gas liquid separator to a polymeric membrane of a membrane separation system, the polymeric membrane having a H₂S/CH₄ selectivity of at least 10 and CO₂/CH₄ selectivity of at least 5 at the pressure, the temperature, and the relative humidity of the natural gas feed stream. The process further includes selectively permeating at least some of the CO₂ and the H₂S of the natural gas feed stream from the gas liquid separator through the polymeric membrane to produce a permeate stream having concentrated CO₂ and H₂S relative to the natural gas feed stream, and thereby producing a retentate stream that does not permeate through the polymeric membrane. The retentate stream has a higher concentration of CH₄ and a lower concentration of CO₂ and H₂S relative to the natural gas feed stream.

A system for separating H₂S and CO₂ out of a natural gas feed stream includes a natural gas feed flow path extending from a gas liquid separator and to a membrane separation system. The natural gas feed flow path is configured to feed the natural gas feed stream at a pressure of at least 20 bar, a temperature of at least 30° C., and a relative humidity of 30% to 95% to the membrane separation system. The system also includes a polymeric membrane of the membrane separation system, the polymeric membrane having a H₂S/CH₄ selectivity of at least 10 and CO₂/CH₄ selectivity of at least 5 at the pressure, the temperature, and the relative humidity of the natural gas feed stream. The membrane separation system is configured to selectively permeate at least some of the CO₂ and the H₂S of the natural gas feed stream through the polymeric membrane to produce a permeate stream having concentrated CO₂ and H₂S relative to the natural gas feed stream, and thereby produce a retentate stream that does not permeate through the polymeric membrane, such that the retentate stream has a higher concentration of CH₄ and a lower concentration of CO₂ and H₂S relative to the natural gas feed stream.

### BRIEF DESCRIPTION OF THE DRAWINGS

These and other objects, features and advantages of the present invention will become better understood referring to the following description and accompanying drawings. The drawings are not considered limiting of the scope of the disclosure. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 shows a schematic diagram of a plant for gas processing in accordance with the prior art.

FIG. 2 shows a schematic diagram of a plant for gas processing with minimal or no gas dehydration before introduction to a membrane separation system, in accordance with an embodiment of this disclosure.

FIG. 3 shows the time-dependent performance of a self-supported cellulose triacetate gas separation membrane for a feed having 15% H₂S and varying levels of relative humidity at 30° C. and 20 bar.

FIG. 4 shows the time-dependent performance of a self-supported cellulose triacetate gas separation membrane for a feed having 15% H₂S and varying levels of relative humidity at 30° C. and 50 bar.

FIG. 5 shows the time-dependent performance of a self-supported cellulose triacetate gas separation membrane for a feed having humid 15% H₂S at 50° C. at 20 bar.

FIG. 6 shows the time-dependent performance of a self-supported cellulose triacetate gas separation membrane for a feed having 15% H₂S at 30° C. and 20 bar at various levels of humidity along with butane and toluene.

FIG. 7 shows the time-dependent performance of a hollow fiber cellulose triacetate gas separation membrane for a feed having 15% H₂S at 30° C. and 20 bar at various levels of humidity.

FIG. 8 shows the effect of feed flow rate on performance of a hollow fiber cellulose triacetate gas separation membrane for a dry and a humid sour (15% H₂S, 5% CO₂) feed mixture.

FIG. 9 shows the time-dependent performance of a polyether block amide-based gas separation membrane at 30° C. and 20 bar in humid sour atmosphere.

FIG. 10 shows the time-dependent performance of a polyether block amide-based gas separation membrane at 30° C. and 40 bar in humid sour atmosphere.

FIG. 11 shows the effect of humidity on a polyether block amide-based gas separation membrane performance in sour atmosphere at humidity levels up to 1700 ppm, 30° C. and 20/40 bar.

FIG. 12 shows the time-dependent performance at varying humidity in the presence of 15% H₂S at 20 bar for a poly(ethylene oxide)-poly(butylene terephthalate) block copolymer-based membrane.

### DETAILED DESCRIPTION

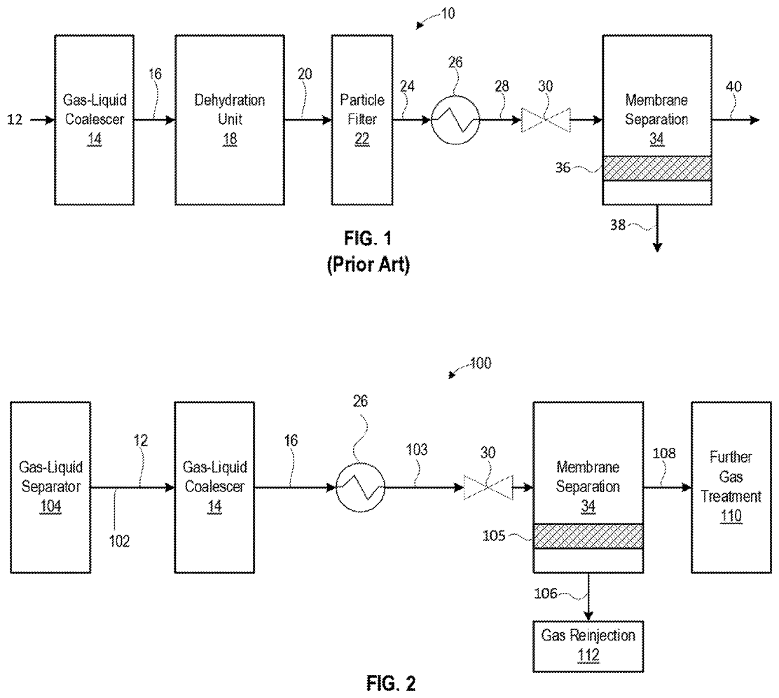

As set forth above, dehydration ‘pre-treatment’ of natural gas feeds is generally done upstream of membrane separation to mitigate the impact of water, which is generally recognized in membrane technologies to reduce the performance of the membrane CO₂ removal for natural gas. This has been shown to be true for natural gas containing CO₂, moisture, CH₄ and other hydrocarbons. An example of this process is shown in FIG. 1.

Specifically, FIG. 1 is a system 10 for sweetening a natural gas feed 12. A gas-liquid coalescer 14 removes aerosols and fine particles from the natural gas feed 12 to produce a coalesced stream 16, which is then transmitted to a dehydration unit 18. The dehydration unit 18 may use a glycol-based process, TSA process, or the like to produce a dehydrated stream 20. The dehydrated stream 20 is then sent to a particle filter 22 to produce a filtered stream 24. A heat exchanger 26 heats the filtered stream 24 to produce a heated stream 28, and a feed valve 30 controls the flow of the heated stream 28 to a membrane separation system 34 having one or more gas separation membranes 36. The heated stream 28, having significantly reduced moisture levels (e.g., less than 10% relative humidity, such as 1% to 2% relative humidity), is then separated generally into a permeate stream 38 and a retentate stream 40. In some embodiments, such as from TEG dehydration, the residual water levels for the heated stream 28 may be as low as 147 ppmv H₂O. The permeate stream 38 contains higher levels of acid gas relative to the retentate stream 40 due to the selective permeability of the one or more membranes 36 of the membrane separation system 34.

In accordance with present embodiments, it is now recognized that, contrary to accepted practice, high H₂S+moisture conditions can, surprisingly, be tolerated in membrane separation processes without an extensive water pre-treatment step. Indeed, in some embodiments, the increased humidity leads to enhanced separation performance. This finding has the potential to significantly simplify the membrane separation process scheme in oil and gas facilities and other commercial settings. An example process in accordance with present embodiments is shown in FIG. 2.

In FIG. 2, a system 100 for sweetening a natural gas feed configured in accordance with present embodiments does not necessarily include the use of a dehydration process as shown in FIG. 1. The natural gas feed stream 12 may, in some embodiments, be received into the system 100 from a reservoir. In the embodiment of FIG. 1, the system 100 includes a natural gas feed flow path 102 extending from a gas liquid separator 104 and to the membrane separation system 34. The gas liquid separator 104 is configured to do a bulk separation of liquids and gases produced from, for example, the reservoir. The gas liquid separator 104 may be, by way of non-limiting example, a slug catcher, 2-phase separator, or 3-phase separator. The natural gas feed flow path 102 is configured to feed the natural gas feed stream 12 to the membrane separation system 34 at a particular temperature, pressure, and relative humidity (e.g., a pressure of at least 20 bar, a temperature of at least 30° C., and a relative humidity of 30% to 95%), and may include various units that operate on the natural gas feed stream 12 to control certain of its properties. For instance, in the system 100, the gas-liquid coalescer 14 receives the natural gas feed stream 12 from the gas liquid separator 104. By way of non-limiting example, the gas-liquid coalescer 14 is configured to remove 99% of water droplets of 0.3 microns and higher. The natural gas feed stream 12 may include enough H₂S such that a sweetening process is appropriate. The natural gas feed stream 12 may have, by way of non-limiting example, an H₂S content of 5 mol % or more, or 10 mol % or more (e.g., between 5 mol % and 25 mol %, such as between 10 mol % and 20 mol %) and a relative humidity of 30% to 95%. The natural gas feed stream 12 may also have a higher H₂S than CO₂ content. For example, the H₂S/CO₂ ratio of the natural gas feed stream 12 may be 1 or greater, 2 or greater, or 3 or greater, such as between 1 and 10, between 2 and 10, or between 3 and 8.

In this embodiment, the feed stream 12 is not dehydrated before the stream is provided to the membrane separation system 34. That is, in the illustrated embodiment, the natural gas feed flow path does not include a dehydration unit configured to dehydrate the natural gas feed stream 12. Thus, the coalesced stream 16 is heated at the heat exchanger 26 (e.g., a temperature-controlled heater) to produce a heated coalesced stream 103, which includes relative humidity levels of up to 95% (e.g., between 30% and 95% relative humidity), and which is controllably fed to the membrane separation system 34. In this way, generally, a sour feed gas (e.g., heated coalesced stream 103) including higher hydrocarbons in the presence of high levels of humidity (e.g., between 30% and 95% relative humidity) is provided to the membrane separation system 34.

In the system 100 of FIG. 2, the heated coalesced stream 103 relative humidity is controlled to a desired level prior to introduction to the membrane separation system 34 having one or more polymeric membranes 104 by use of the temperature-controlled heater 26 and the gas-liquid coalescer 14. Again, the dehydration unit 18 is not necessarily involved in controlling humidity of the feed. However, in certain embodiments, the natural gas feed stream 12 may undergo some water removal in the system 100 (e.g., using a dehydration unit), but in lesser amounts than is typical (e.g., such that the relative humidity of the feed to the membrane separation system 34 is at least 30%).

In some embodiments of the system 100, the natural gas feed stream (the heated coalesced stream 103) is controlled to a desired temperature level prior to introduction to the membrane separation system 34 using the temperature-controlled heater 26 and the gas-liquid coalescer 14. By way of non-limiting example, the temperature of the heated coalesced stream 103 (the natural gas stream fed to the membrane separation system 34) may be controlled to be at least 30° C., such as between 30° C. and 65° C. (e.g., from 30° C. or 40° C. to 40° C., 50° C., 60° C., or 65° C.).

The membrane separation system 34 produces a permeate stream 106 and a retentate stream 108 (sometimes referred to as a non-permeate stream), wherein the retentate stream 108 has a reduced concentration of H₂S and CO₂ compared to the natural gas feed stream 12. By way of non-limiting example, the retentate stream 108 may have an H₂S level of between 1 mol % and 15 mol %, and a CO₂ level of between 0.5 mol % and 3 mol %.

In some embodiments, the feed pressure of the natural gas feed stream (the heated coalesced stream 103) into the one or more polymeric membranes 104 is maintained by controlling the backpressure on the non-permeate stream (the retentate stream 108). By way of non-limiting example, the pressure of the heated coalesced stream 103 (the natural gas stream fed to the membrane separation system 34) may be controlled to be at least 20 bar, such as between 20 bar and 70 bar, or between 20 bar and 60 bar (e.g., from 20 bar, 30 bar, or 40 bar to 30 bar, 40 bar, 50 bar, 60 bar, or 70 bar).

In some embodiments, the polymeric membrane 104 may have a hollow fiber construction, a spiral wound construction, or a combination thereof. The polymeric membrane may be formed from a cellulose triacetate (CTA) polymer, a cellulose acetate (CA) polymer, a polyethylene block amide copolymer, polydimethylsiloxane (PDMS), a poly(ethylene oxide)-poly(butylene terephthalate) block copolymer, a polyimide, or any combination thereof.

The one or more polymeric membranes 104, in the operating conditions set forth above, generally have a selectivity for H₂S and CO₂ over CH₄, meaning that H₂S and CO₂ more readily permeate through the one or more polymeric membranes 104 when compared to CH₄. These selectivities may be represented by a ratio of H₂S/CH₄ and a ratio of CO₂/CH₄. By way of non-limiting example, the one or more polymeric membranes 104, in the humid conditions set forth above, surprisingly have a H₂S/CH₄ selectivity of at least 10, such as between 10 and 40 at a temperature of between 30° C. and 60° C. and a pressure of between 20 bar and 50 bar. By way of further non-limiting example, the one or more polymeric membranes 104, in the humid conditions set forth above, surprisingly have a CO₂/CH₄ selectivity of at least 5, at least 6, or at least 7, such as between 5 and 40, between 6 and 40, or between 7 and 40 at a temperature of between 30° C. and 60° C. and a pressure of between 20 bar and 50 bar.

As illustrated, the retentate stream 108 may be transmitted to various further gas treatment systems, generally indicated at 110. The further gas treatment 110 may include various systems or units that further process the stream for eventual transmission as, e.g., sales gas. The permeate stream 106, having higher H₂S, may be transmitted to a gas reinjection system 112 which, for example, may compress and reinject the permeate stream 106 into a disposal well or other reservoir.

### EXAMPLES

The following illustrative examples are intended to be non-limiting. As set forth above, the present inventors have found that surprisingly, high H₂S+moisture conditions can be tolerated in membrane separation processes without an extensive water pre-treatment step. Indeed, in some embodiments, the increased humidity leads to enhanced separation performance.

### Cellulose Tri-acetate Membranes

Dense-film cellulose tri-acetate (CTA) membranes were thoroughly characterized with H₂S-containing mixtures. The separation performance of these membranes in H₂S-containing mixtures (CH₄/CO₂/H₂S, 80/5/15) were evaluated at 30° C. and 50° C. at 20 bar, 35 bar, and 50 bar

### Self-supported Membranes

Cellulose (tri)-acetate (CTA) membrane samples were made using CTA (degree of substitution (DS) ˜2.7) from Eastman (CA-398-100), with dichloromethane (DCM) as solvent during casting. The thickness of the samples was approximately 40-60 μm.

For the testing of the self-supported CTA samples, a high-pressure Millipore 47 mm HP Holder (active area 9.6 cm²) has been applied. Connections for feed, retentate, sweep and permeate streams are installed with the help of Swagelok connectors. Circular CTA samples for the permeation were easily punched out from the free-standing CTA film and applied in the module. In between the porous filter plate and the CTA film a porous 25 μm-thick polypropylene (PP) film (CELGARD® 2500) to prevent the CTA film from being mechanically damaged during the high-pressure operation. Without the CELGARD® film it is observed that the CTA membrane is mechanically deformed (around 5 micron) due to extrusion into the openings of the Millipore back-pressure support screen.

All gas permeation measurements were conducted using the constant-pressure method, analogue to ASTM D3985-17, though employing gas chromatography (GC) analysis on the permeate stream, in a home-made permeation set-up under mixed gas conditions. The setup is designed to withstand a pressure up to 92 bar, and the membrane module is placed in a Memmert UF450 forced air circulation oven for temperature control. Automated mass flow controllers (MFC) (Bronkhorst High-Tech) are used to control the gas supply to the feed and permeate side (if required) of the membrane module. A controlled evaporation mixing (CEM) system is installed for the accurate introduction of low levels of humidity (Bronkhorst High-Tech, CEM W-101A-C10-K, size 2-100 μg/h). The pressure of the feed side is controlled with the help of a back-pressure controller (Bronkhorst High-Tech, P-512C equipped with F-033C control valve, max. 92 bar). At the permeate side Ar is applied as sweep flow. The permeate side is always at atmospheric pressure, and the permeate flow is measured using an automated mass flow meter (Bronkhorst High-Tech, F-101D, size 100 mL/min). A μ-GC (Agilent 490) equipped with a thermal conductivity detector (TCD) is employed to monitor the permeate composition. The μ-GC is calibrated for small concentrations of CO₂ (0-12 vol. %), CH₄ (0-5 vol. %) and H₂S (0-20 vol. %)) in Ar using CO₂/CH₄/H₂S mixtures prepared in the lab using calibrated flow controllers. A good linear fit (R2=≥0.999) is obtained for the GC response as function of CO₂, H₂S, and CH₄ content. The flux of the respective gaseous components is calculated from the measured absolute permeate flow and the permeate composition measured by the GC. Permeance values are expressed at 20° C. and 1.013 bar (1 atm) applying units of barrer.

Bottled pre-mixed gas cylinders (Nippon gas) were applied. Investigated gas mixtures include a 15% H₂S and 5% CO₂ in CH₄ mixture, and a mixture containing butane (3%) and a trace amount of toluene (300 ppm) maintaining 15% H₂S and 5% CO₂. Two temperatures—30° C. and 50° C., and three pressures, ranging from 20 bar to 50 bar, were considered in the study. Table 1 and Table 2 provide an overview of the varying test conditions for the different samples that were investigated.

TABLE 1
CTA self-supported membrane samples and conditions investigated.

| | Thick- | | Humid | | Humid | | Humid |
|---|---|---|---|---|---|---|---|
| | ness | 5% | 5% | 15% | 15% | C₄/ | C₄/ |
| Sample | [μm] | CO₂ | CO₂ | H₂S | H₂S | toluene | toluene |
| CTA#2 | | x | | | | | |
| CTA#3 | | x | | x | | | |
| CTA#5 | 44.9 ± 5.1 | x | x | | | | |
| CTA#6 | 46.3 ± 2.8 | x | | x | x | | |
| CTA#7 | 45.6 ± 5.6 | x | | x | x | | |
| CTA#9 | 63.1 ± 7.3 | x | | x | | x | |
| CTA#10 | 34.9 ± 1.5 | x | | x | | x | x |

TABLE 2
CTA hollow fiber membrane samples and
conditions investigated.

| | | Humid | | Humid | | Humid |
|---|---|---|---|---|---|---|
| | 5% | 5% | 15% | 15% | C₄/ | C₄/ |
| Sample | CO₂ | CO₂ | H₂S | H₂S | toluene | toluene |
| C-CTA-11-2B | x | | x | x | | |
| C-CTA-11-2R-X | x | | x | x | | |
| C-CTA-11-2R-Y | x | | x | x | x | x |

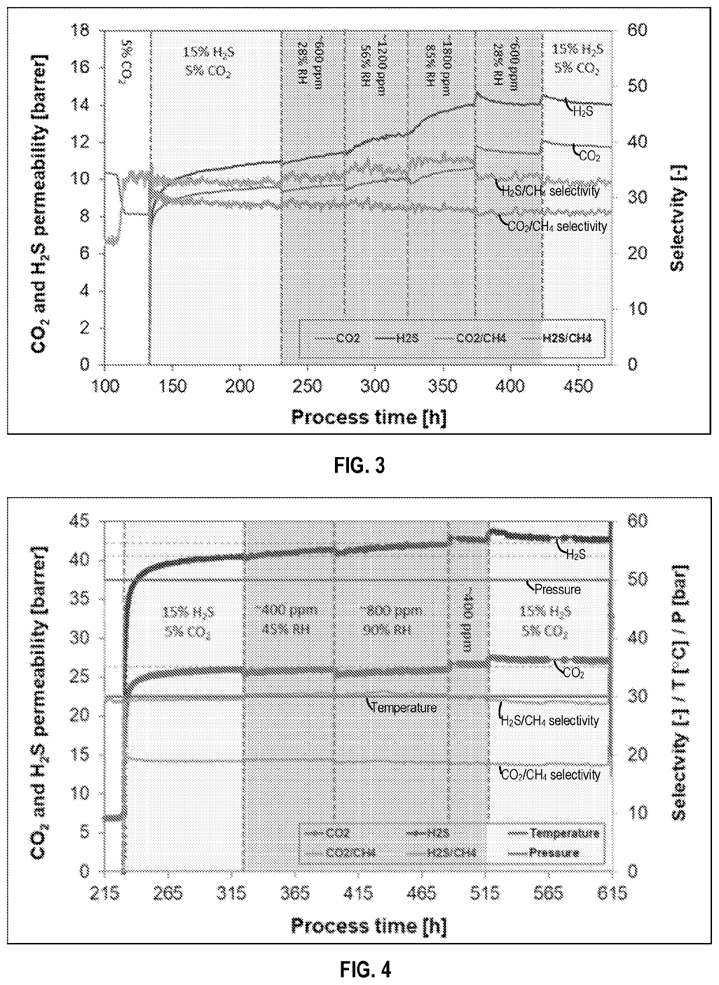

The performance of the CTA samples was investigated in humid sour feed gas streams containing 15% H₂S. FIG. 3 shows the time-dependent performance in the presence of 15% H₂S at 30° C. during humidity exposure up to 90% RH at 20 bar (CTA#7, FIGS. 3) and 50 bar (CTA#6, FIG. 4), respectively. Initially the performance is left to stabilize in the sour feed gas (5% CO₂, 15% H₂S in CH₄) for around 4 days. This is to establish a proper baseline prior to the humidity introduction. Then, the performance in humid 15% H₂S is investigated at varying water vapor content over a period of around 200 hours. Finally, the performance in the dry sour feed gas (5% CO₂, 15% H₂S in CH₄) is again verified to investigate any hysteresis effects.

At 20 bar (FIG. 3, 130 h) the introduction of H₂S results in a minor gradually increasing behavior of both the CO₂ and H₂S permeability over time, combined with a decrease in CO₂/CH₄ selectivity. Compared to the permeability prior to any H₂S exposure, the H₂S introduction results in an increase in CO₂ permeability from 8.1 to 9.6 barrer at the expense of a reduced CO₂/CH₄ selectivity from 33.6 to 28.6 under the current conditions (30° C. and 20 bar). The H₂S permeability equals 10.9 barrer. Thereafter (FIG. 3, 230 h ) humidity is introduced at a water content of 600 ppm (28% RH). This results in a minor immediate decrease in CO₂ and H₂S permeability, followed by a gradually increasing behavior. During the next 2 days of operation at 600 ppm the CO₂ and H₂S permeability has increased from respectively 9.4 and 10.9 barrer to 9.7 and 11.5 barrer. The permeability increase occurs at seemingly unchanged CO₂/CH₄ and H₂S/CH₄ selectivity. The further increase in humidity, first to 1200 and then to 1800 ppm results in a similar effect. Initially both the CO₂ and H₂S permeability show an immediate decrease, which was followed by a slow gradually increasing behavior. The reduction in humidity from 1800 to 600 ppm (FIG. 3, 375 h ) results in the opposite behavior. An initial minor increment followed by a gradually decreasing trend in permeability is seen upon the reduction and subsequently complete removal of humidity, respectively.

Comparing initial and post-humid membrane performance shows that the humidity exposure has increased the CO₂ and H₂S permeability from respectively 9.6 and 10.9 barrer to 11.8 and 14.2 barrer, even after 2 days of operation in dry gas. The H₂S/CH₄ selectivity is not affected by the humid operation while the CO₂/CH₄ selectivity obtained after the humid operation is somewhat lower compared to the initial value, 27.0 compared to 28.6. The increase in permeability combined with the decrease in CO₂/CH₄ selectivity with pressure is believed to be related to plasticization phenomena due to the high condensability of H₂S and CO₂, which increased mobility of the polymer chain segments of the membrane-thereby increasing gas permeation. The main performance parameters corresponding to FIG. 3 are set forth in Table 4 below.

TABLE 4
Performance parameters as function of time, CTA#7, T = 30° C. and 20 bar.

| Process | | T | P | Humidity | CO₂ | CH₄ | H₂S | | |
|---|---|---|---|---|---|---|---|---|---|
| time [h] | Feed | [° C.] | [bar] | [ppm] | [barrer] | [barrer] | [barrer] | CO₂/CH₄ | H₂S/CH₄ |
| 130 | 5% CO₂, | 30 | 20 | 0 | 8.1 | 0.2 | — | 33.6 | — |
| | 95% CH₄ | | | | | | | | |
| 225 | 5% CO₂, | 30 | 20 | 0 | 9.6 | 0.3 | 10.9 | 28.6 | 32.7 |
| 230 | 15% H₂S, | 30 | 20 | 600 | 9.4 | 0.3 | 10.9 | 28.9 | 33.6 |
| 275 | 80% CH₄ | 30 | 20 | 600 | 9.7 | 0.3 | 11.5 | 28.9 | 34.1 |
| 280 | | 30 | 20 | 1200 | 9.7 | 0.3 | 11.8 | 29.5 | 35.9 |
| 320 | | 30 | 20 | 1200 | 10.1 | 0.4 | 12.4 | 28.5 | 35.0 |
| 325 | | 30 | 20 | 1800 | 9.9 | 0.4 | 12.8 | 28.2 | 36.3 |
| 370 | | 30 | 20 | 1800 | 10.6 | 0.4 | 14.0 | 27.9 | 36.8 |
| 375 | | 30 | 20 | 600 | 11.7 | 0.4 | 14.5 | 27.1 | 33.5 |
| 420 | | 30 | 20 | 600 | 11.8 | 0.4 | 14.3 | 27.4 | 32.8 |
| 425 | | 30 | 20 | 0 | 12.0 | 0.4 | 14.4 | 27.7 | 33.3 |
| 475 | | 30 | 20 | 0 | 11.8 | 0.4 | 14.2 | 27.0 | 32.6 |

Referring to FIG. 4, at 50 bar a similar behavior is observed though plasticization upon H₂S introduction at 50 bar is much larger, explained by the higher partial pressure of H₂S in contact with the membrane. The H₂S introduction at 50 bar results in a large increase in CO₂ permeability from 6.9 to 26.0 barrer (_{9.6} barrer at 20 bar) at the expense of a reduced CO₂/CH₄ selectivity from 29.2 to 19.0. The H₂S permeability after 100 h of stabilization equals 40.5 barrer (10.9 barrer at 20 bar). Then humidity is introduced at a level of 400 ppm (FIG. 4, 320 h, 45% RH). Similar to what was observed at 20 bar in FIG. 3, this results in a minor immediate decrease in CO₂ permeability, which is followed by a gradual increasing trend observed especially for the H₂S permeability. During 3 days of operation the CO₂ and H₂S permeability increases from respectively 25.4 and 40.2 barrer to 26.0 and _{41.3} barrer. The humidity introduction triggers also a minor increase in the H₂S/CH₄ selectivity at unchanged CO₂/CH₄ selectivity. The subsequent further increase in humidity to 800 ppm generates a similar response for the permeability. Initially, a minor immediate drop in permeability is observed, followed by a slow but gradually increasing behavior.

Compared to the observations at 20 bar shown in FIG. 3, the various humidity levels affects the membrane performance to a minor effect at 50 bar as shown in FIG. 4, both in absolute and relative amount. It is possible that the additional swelling and/or plasticization effect of humidity at 50 bar is minor compared to the already highly plasticized/swollen membrane at 50 bar and 15% H₂S concentration. The reduction in humidity at 50 bar from 800 to 400 ppm (FIG. 4, 480 h ) and subsequently complete removal of humidity (FIG. 4, 515 h ) results in the opposite behavior. An initial minor decrease in permeability is followed by a gradually decreasing trend. It should be noted that from the moment the humidity was decreased (˜475 hours) both the CO₂/CH₄ and H₂S/CH₄ selectivity seemingly start to decline. The exact reason for this is unclear but may be related to the drying of acidic droplets on the membrane surface possibly formed during the high humidity conditions (800 ppm ≈95% RH). The main performance parameters are set forth in Table 5 below.

TABLE 5
Performance parameters as function of time, CTA sample membrane, T = 30° C.
and 50 bar.

| Process | | T | P | Humidity | CO₂ | CH₄ | H₂S | | |
|---|---|---|---|---|---|---|---|---|---|
| time [h] | Feed | [° C.] | [bar] | [ppm] | [barrer] | [barrer] | [barrer] | CO₂/CH₄ | H₂S/CH₄ |
| 220 | 5% CO₂, | 30 | 50 | 0 | 6.9 | 0.3 | — | 29.2 | — |
| | 95% CH₄ | | | | | | | | |
| 320 | 5% CO₂, | 30 | 50 | 0 | 26.0 | 1.4 | 40.5 | 19.0 | 29.6 |
| 325 | 15% H₂S, | 30 | 50 | 400 | 25.4 | 1.3 | 40.2 | 19.2 | 30.4 |
| 395 | 80% CH₄ | 30 | 50 | 400 | 26.0 | 3.3 | 41.3 | 19.2 | 30.6 |
| 400 | | 30 | 50 | 800 | 25.5 | 1.4 | 41.2 | 18.8 | 30.4 |
| 465 | | 30 | 50 | 800 | 25.7 | 1.4 | 41.9 | 18.8 | 30.5 |
| 475 | | 30 | 50 | 400 | 25.9 | 1.4 | 42.0 | 18.7 | 30.4 |
| 515 | | 30 | 50 | 400 | 26.6 | 1.4 | 42.6 | 18.6 | 29.8 |
| 520 | | 30 | 50 | 0 | 27.4 | 1.5 | 43.6 | 18.5 | 29.4 |
| 610 | | 30 | 50 | 0 | 27.1 | 1.5 | 42.7 | 18.3 | 28.8 |

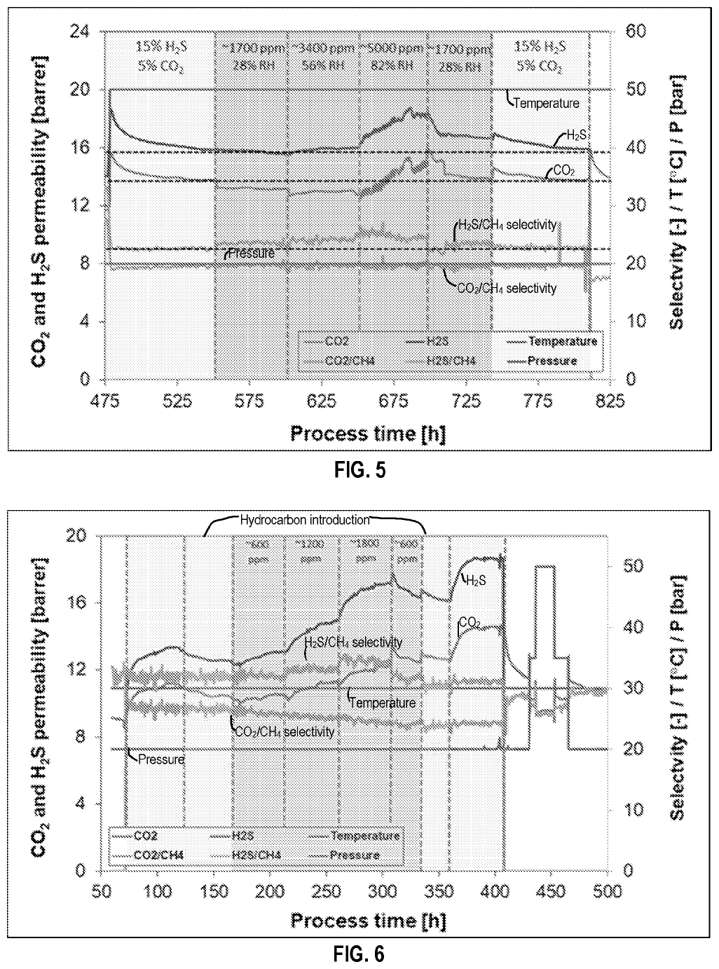

Subsequently the temperature was increased to 50° C. and the humidity effect investigated at this temperature, with the pressure maintained at 20 bar. FIG. 5 shows the time-dependent performance of sample CTA#7 in the presence of humid 15% H₂S at 50° C. at 20 bar.

Initially the performance is left to stabilize in the sour feed gas (5% CO₂, 15% H₂S in CH₄) at this temperature (50° C.) for 4 days. This is to establish a proper baseline prior to the humidity introduction. Then, the performance in humid 15% H₂S is investigated at subsequently 1700, 3400, 5000 and 1700 ppm water vapor content over a period of 192 hours. Because of the higher equilibrium water vapor pressure at 50° C. (12.3 kPa vs 4.25 kPa at 30° C.) higher levels of water content (up to 5000 ppm) could be investigated while still staying below 100% RH. Finally, the performance in the dry sour feed gas (5% CO₂, 15% H₂S in CH₄) is again verified to investigate possible hysteresis. The main performance parameters are given in Table 6.

TABLE 6
Performance parameters as function of time, CTA#7, T = 50° C. and 20 bar.

| Process | | T | P | Humidity | CO₂ | CH₄ | H₂S | | |
|---|---|---|---|---|---|---|---|---|---|
| time [h] | Feed | [° C.] | [bar] | [ppm] | [barrer] | [barrer] | [barrer] | CO₂/CH₄ | H₂S/CH₄ |
| 550 | 5% CO₂, | 50 | 20 | 0 | 13.8 | 0.7 | 15.9 | 19.5 | 22.5 |
| | 15% H₂S, | | | | | | | | |
| 555 | 80% CH₄ | 50 | 20 | 1700 | 13.2 | 0.7 | 15.9 | 19.6 | 23.5 |
| 600 | | 50 | 20 | 1700 | 13.2 | 0.7 | 15.6 | 19.6 | 23.2 |
| 505 | | 50 | 20 | 3400 | 12.8 | 0.7 | 15.7 | 19.7 | 24.1 |
| 645 | | 50 | 20 | 3400 | 13.0 | 0.7 | 16.0 | 19.7 | 24.1 |
| 650 | | 50 | 20 | 5000 | 12.8 | 0.6 | 16.1 | 20.0 | 25.0 |
| 695 | | 50 | 20 | 5000 | 14.6 | 0.7 | 18.3 | 19.7 | 24.6 |
| 700 | | 50 | 20 | 1700 | 15.6 | 0.8 | 18.2 | 39.7 | 23.1 |
| 745 | | 50 | 20 | 1700 | 13.9 | 0.7 | 16.7 | 19.7 | 23.6 |
| 800 | | 50 | 20 | 0 | 13.8 | 0.7 | 16.0 | 19.7 | 22.8 |
| 825 | 5% CO₂, | 50 | 20 | 0 | 13.8 | 0.7 | — | 21.2 | — |
| | 95% CH₄ | | | | | | | | |

After stabilization in H₂S for approximately 4 days, after around 550 hours total process time, humidity is introduced at a level of 1700 ppm. This results in a minor immediate decrease in CO₂ permeability, but is followed by a rather constant performance. First at higher humidity (3400 ppm, 56% RH) the permeability starts to show an increasing trend. The further increase in humidity (5000 ppm, 82% RH) results in a steep increasing permeability, which for H₂S flattens of at the end of the exposure. The reduction in humidity from 5000 to 1700 ppm and the subsequent complete humidity removal results in the opposite behavior; the reduction of the water content results in a limited permeability increase, which is followed by a gradual stabilization. Comparing the performance before and after the humidity tests (total humid duration: 8 days), little differences can be observed, suggesting an appropriate chemical stability of the CTA in humid sour feed gas under the conditions investigated.

### Effect of Higher Hydrocarbons

Subsequently measurements were performed in the presence of higher hydrocarbons (3% butane and 300 ppm toluene) in the presence of humidity. For this investigation new membrane samples were applied to provide a valid comparison of membrane performance under different test conditions.

CTA performance was investigated in sour feed gas streams containing 15% of H₂S including higher hydrocarbons (3% butane and 300 ppm toluene) at humidity at levels between 600-1800 ppm (20 bar, 30° C.; RH=28-85%). No information on the performance of CTA membranes in the co-existence of both humidity and condensable hydrocarbons is available in literature. The results are presented in FIG. 6 during which the membrane (CTA#10) was operated in humid 15% H₂S including higher hydrocarbons from a process time of 170 h. Initially, 15% H₂S and C₄/toluene were introduced at a process time of respectively 70 and 125 hours. The CO₂ (11.2 versus 10 barrer) and H₂S (13.4 versus 11.6 barrer) permeability in the presence of 15% H₂S are slightly higher. This can be explained by the lower thickness of CTA#10 leading to a potential larger effect of plasticization. The subsequent introduction of butane and toluene reduces the permeability by about 8%.

Humidity is then introduced at a level of 600 ppm. This results in a minor immediate decrease in permeability, which is followed by a slow gradual increasing trend. During 2 days of humid operation the CO₂ and H₂S permeability increases from respectively 10.2 and 12.3 barrer to 10.5 and 13.1 barrer. This increase occurs at seemingly unchanged H₂S/CH₄ selectivity, but at decreasing CO₂/CH₄ selectivity. The further increase in humidity to 1200 ppm and thereafter to 1800 ppm generates a similar response on the permeability; a minor immediate drop is observed, followed by a gradually increasing behavior. Compared to dry operation, the CO₂ and H₂S permeability at 1800 ppm humidity increases from respectively 10.2 and 12.3 barrer to 12.2 (+19%) and 17.1 (+38%) barrer. The larger increase in H₂S permeability results in an increased H₂S/CH₄ selectivity during humid operation. Note, however, the gradual decrease in CO₂/CH₄ selectivity during the humid operation. The reduction in humidity from 1800 to 600 ppm and subsequently complete removal of humidity results in the opposite behavior; an initial minor increase in permeability followed by a gradually decreasing trend is observed. The permeability enhancement remains after humidity removal, or it at least takes time before it would return to its original value. The slow kinetics can be explained by the fact that the experiments were performed on relatively thick self-supported membrane samples.

### Permeation Properties of CTA Hollow Fiber Membrane Samples

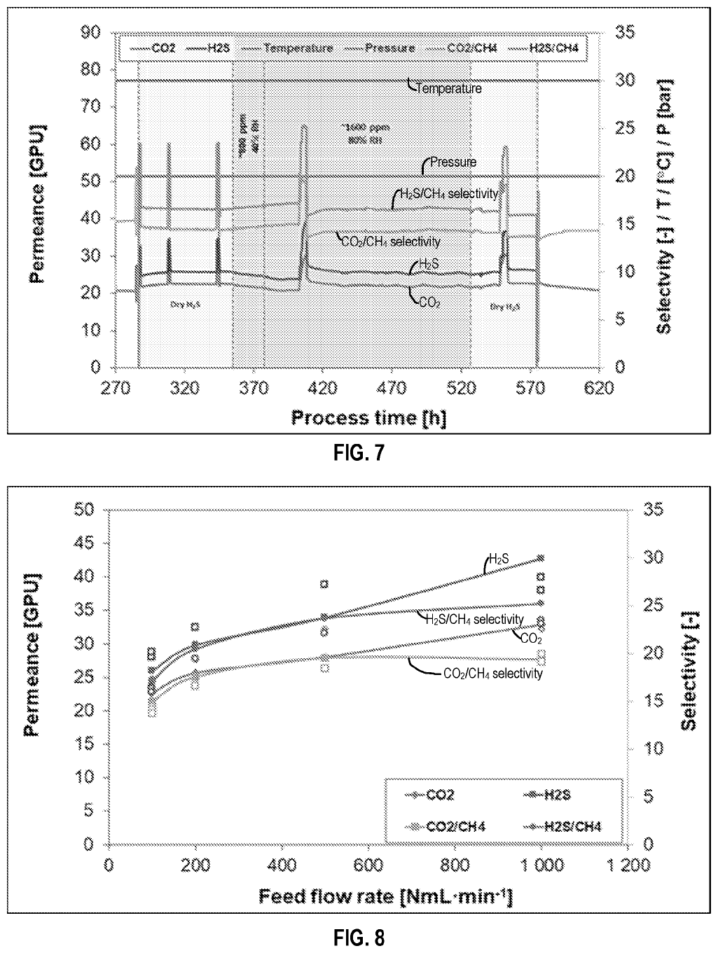

For module C-CTA-11-2B, 15% H₂S and subsequently humidity was introduced at a feed pressure of 10 bar. The H₂S introduction results in a slight increase in CO₂ permeance (34.2 from 33.8 gas permeation units (GPU)) at otherwise unchanged feed flow rate. The CO₂/CH₄ selectivity decreases slightly upon H₂S introduction, 22.2 to 21.6, at a H₂S permeance and H₂S/CH₄ selectivity of 38 GPU and 24.2, respectively. The humidity addition (˜1600 ppm, ˜40% RH) at 10 bar between 90 h and 165 h slightly inhibits the obtained CO₂ and H₂S permeance, with negligible variations on CO₂/CH₄ and H₂S/CH₄ selectivity. Subsequently, the same investigation was performed at 20 bar. FIG. 7 shows the performance as function time during the subsequent introduction of 15% H₂S, in addition to two levels of humidity, respectively.

Upon H₂S introduction, an initial minor CO₂ permeance inhibition is observed, which is followed by a gradual increasing behavior. The CO₂/CH₄ selectivity decreases slightly, 20.9 to 18.9. This aligns well with the observation for the symmetrically thick CTA films. At 20 bar, the H₂S permeance and H₂S/CH₄ selectivity were 32 GPU (not fully stabilized) and 23.3, respectively. Table 7 compares the effect of H₂S introduction as function of pressure. It can clearly be seen that the H₂S effect is clearly enhanced at higher pressure, e.g., from 35 bar, illustrating the controlled plasticization benefits of H₂S.

TABLE 7
Module C-CTA-11-2B, effect of H₂S introduction as function
pressure. T = 30° C. and 20-35 bar. Data recorded at stage-cut of <5%.

| | T | | CO₂ | H₂S | CO₂/ | H₂S/ |
|---|---|---|---|---|---|---|
| Condition | [° C.] | P [bar] | [barrer] | [barrer] | CH₄ | CH₄ |
| 5% CO₂ | 30 | 10 | 33.8 | — | 22.2 | — |
| 15% H₂S | 30 | 10 | 34.2 | 38.1 | 21.6 | 24.2 |
| 5% CO₂ | 30 | 20 | 29.9 | — | 20.9 | — |
| 15% H₂S | 30 | 20 | 32.2 | 37.9 | 20.0 | 23.4 |
| 5% CO₂ | 30 | 35 | 21.0 | — | 17.4 | — |
| 15% H₂S | 30 | 35 | 38.4 | 50.0 | 15.5 | 20.1 |

The humidity addition at around 355 h (˜800 ppm, ˜40% RH) at 20 bar slightly inhibits the obtained CO₂ and H₂S permeance, at close to unchanged CO₂/CH₄ and H₂S/CH₄ selectivity. During the humidity addition (˜800 ppm, 40% RH), however, the membrane was operated at relatively low feed flow rate resulting in a stage cut of around 20%. Between 400 h and 410 h the effect of stage-cut on performance in the humid 15% H₂S feed mixture was investigated.

FIG. 8 shows the effect of feed flow rate on performance in respectively the dry and humid sour (15% H₂S, 5% CO₂) feed mixture. It can be seen from FIG. 8 that the humidity addition results in an increasing behavior of the H₂S/CH₄ selectivity with little change on CO₂/CH₄ selectivity. Also, an increase in H₂S permeance in the presence of humidity is observed at low stage-cut, with the opposite behavior at high stage-cut. Humidity shows little to no effect on CO₂ permeance compared to how the H₂S permeance is affected.

### Rubbery/polyamide-polyether Block Copolymer Membranes

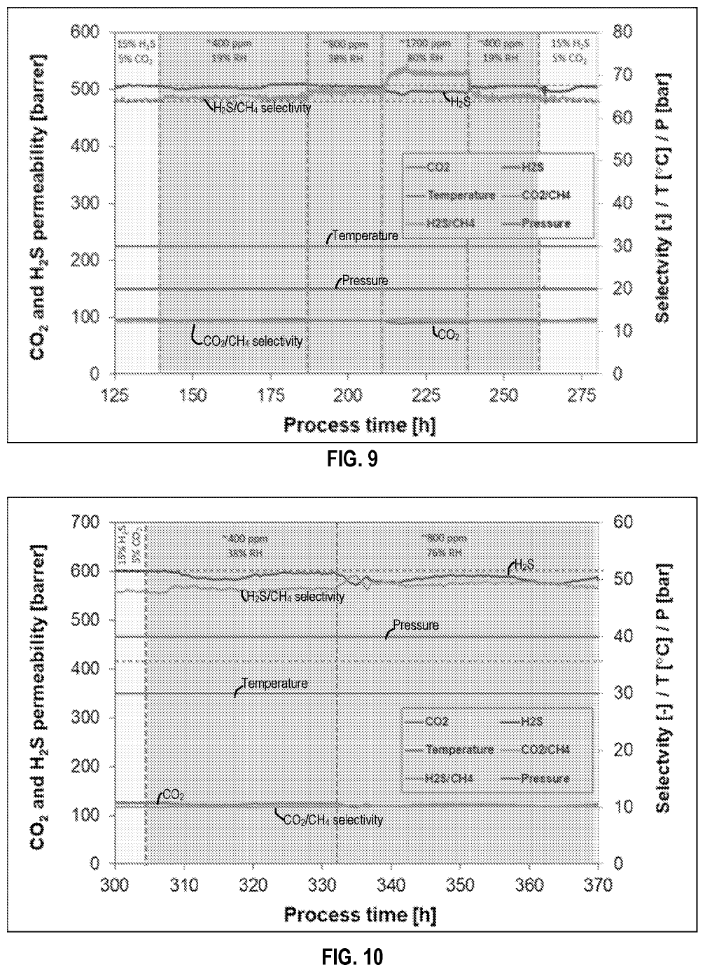

The performance of PEBAX® MH 1657 polyether block amide (a thermoplastic elastomer made of flexible polyether and rigid polyamide) based membranes in humid sour atmosphere was investigated at humidity levels between 400-1700 ppm (20 bar, 30° C.; RH=19-80%) and 400-800 ppm (40 bar, 30° C.; RH=38-76%). FIG. 9 shows the time-dependent performance at varying humidity in the presence of 15% H₂S at 20 bar.

Humidity is introduced after around 140 h at a level of 400 ppm (18% RH at 20 bar and 30 C). This seemingly results in a minor decrease in H₂S permeability, but the performance fluctuates around its original value for the subsequent 2 days of humid operation. Upon humidity introduction the H₂S/CH₄ selectivity shows a minor increase. A similar behavior is observed during the subsequent increase in humidity content to ˜800 and ˜1700 ppm. Compared to dry operation, the CO₂ and H₂S permeability at 1700 ppm humidity decreases from respectively 96.7 and 507 barrer to 90.5 (−6%) and 496 (−2%) barrer. The CO2/CH4 and H₂S/CH₄ selectivity shows an increase in selectivity upon humidity addition, with 5% (CO₂/CH₄) and 10% (H₂S/CH₄). The reduction in humidity from 1800 to 400 ppm and subsequently complete removal of humidity results in the opposite behavior and the effect of permeability inhibition and selectivity increase if reversed. After the humid operation, the performance is relatively similar compared to the initial values.

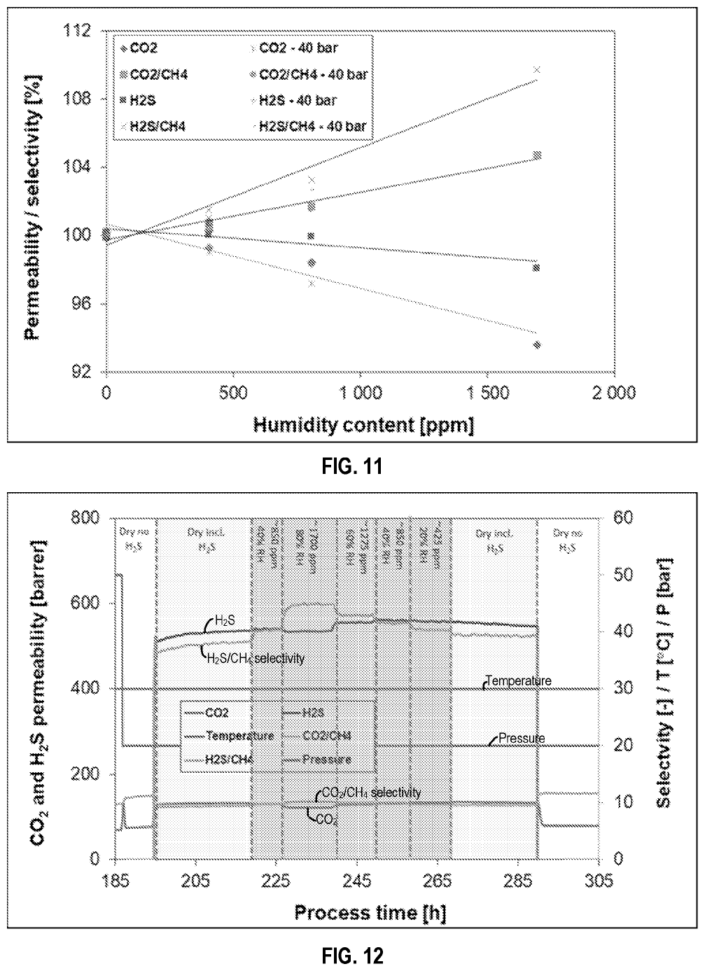

FIG. 10 shows the performance of PEBAX® MH 1657 polyether block amide in humid sour atmosphere at 40 bar at humidity levels between 400 and 800 ppm. A similar trend as described above at 20 bar was observed at 40 bar. Upon humidity introduction the permeability slightly decreases at a minor increase in selectivity. FIG. 11 summarizes the effect of humidity on the performance of PEBAX® MH 1657 polyether block amide in sour atmosphere at humidity levels up to 1700 ppm, 30° C. and 20/40 bar. The performance in dry conditions is set to 100%.

FIG. 11 shows for example that the H₂S/CH₄ selectivity increases with 10% under highly humidified conditions. In total the sample was tested for 450 h out which 360 h in the presence of H₂S, and 190 h in the presence of humidity and H₂S. The main performance parameters are given in Table 8.

TABLE 8
Performance parameters as function of time, PEBAX ® MH 1657
polyether block amide, T = 30° C. and 20-50 bar.

| Process | | T | P | Humidity | CO₂ | CH₄ | H₂S | | | Stage |
|---|---|---|---|---|---|---|---|---|---|---|
| time [h] | Feed | [° C.] | [bar] | [ppm] | [barrer] | [barrer] | [barrer] | CO₂/CH₄ | H₂S/CH₄ | cut |
| 50 | 5% CO₂, | 30 | 20 | — | 97.3 | 7.8 | 509 | 12.5 | 65.3 | 2.6 |
| 65 | 15% H₂S, | 30 | 35 | — | 116.1 | 10.9 | 554 | 10.7 | 51.1 | 5.1 |
| 85 | 80% CH₄ | 30 | 50 | — | 123.7 | 13.1 | 520 | 9.4 | 59.7 | 7.1 |
| 100 | | 30 | 35 | — | 113.9 | 10.9 | 527 | 10.5 | 48.5 | 4.9 |
| 120 | | 30 | 20 | — | 95.9 | 7.9 | 488 | 12.2 | 62.2 | 2.5 |
| 135 | 5% CO₂, | 30 | 20 | 0 | 96.9 | 7.9 | 507 | 12.3 | 64.2 | 1.6 |
| 180 | 15% H₂S, | 30 | 20 | 404 | 97.0 | 7.9 | 510 | 12.3 | 64.8 | 1.6 |
| 210 | 80% CH₄ | 30 | 20 | 808 | 95.2 | 7.6 | 506 | 12.5 | 66.8 | 1.6 |
| 230 | | 30 | 20 | 1695 | 90.5 | 7.1 | 496 | 12.8 | 70.4 | 1.6 |
| 260 | | 30 | 20 | 404 | 96.0 | 7.8 | 506 | 12.4 | 65.1 | 1.6 |
| 275 | | 30 | 20 | 0 | 96.5 | 7.9 | 505 | 12.3 | 64.2 | 1.6 |
| 300 | 5% CO₂, | 30 | 40 | 0 | 124.8 | 12.4 | 596 | 10.1 | 48.1 | 3.8 |
| 330 | 15% H₂S, | 30 | 40 | 404 | 123.6 | 12.3 | 592 | 10.1 | 48.4 | 3.7 |
| 350 | 80% CH₄ | 30 | 40 | 806 | 121.3 | 11.9 | 585 | 10.2 | 49.3 | 3.7 |

Poly(ethylene oxide)-poly(butylene terephthalate) (PEO-PBT) block copolymer-based membranes:

The performance of POLYACTIVE™ 1500 poly(ethylene oxide)-poly(butylene terephthalate) block copolymer having a molecular weight of 1500 g/mol, in humid sour atmosphere was investigated at humidity levels between 400-680 ppm (50 bar, 30° C.; RH=48-80%). Initially the effect of the feed flow rate was investigated to find an optimum or trade-off with respect to the feed flow rate/stage cut during the longer-term exposure.

FIG. 12 shows the time-dependent performance of POLYACTIVE™M 1500 at 30° C. and 20 bar in humid sour atmosphere. Feed flow rate was 250 NmL/min, stage-cut ˜1%.

Initially the performance was left to stabilize in dry conditions in the presence of H₂S. After around 220 h ˜850 ppm and subsequently ˜1700 ppm of humidity was introduced. This seemingly decrease both the CO₂ and H₂S permeability to a minor extent, whereas it increases both the CO₂/CH₄ and H₂S/CH₄ selectivity. The reduction in humidity to 400 ppm and subsequently complete removal of humidity results in the opposite behavior and the effect of permeability inhibition and selectivity increase if reversed.

It should be noted that only the components relevant to the disclosure are shown in the figures, and that many other components normally part of a gas processing, an oil processing and/or a gas injection system are not shown for simplicity. From the above description, those skilled in the art will perceive improvements, changes and modifications.

It is noted that, as used in this specification and the appended claims, the singular forms “a,” “an,” and “the,” include plural references unless expressly and unequivocally limited to one referent. Further, unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

What is claimed is:

1. A process of separating H₂S and CO₂ out of a natural gas feed stream, comprising:
flowing the natural gas feed stream out of a gas liquid separator at a pressure of at least 20 bar, a temperature of at least 30° C., and a relative humidity of at least 30%, wherein the natural gas feed stream from the gas liquid separator has a H₂S/CO₂ ratio of 3 or greater;
feeding the natural gas feed stream from the gas liquid separator to a polymeric membrane of a membrane separation system, the polymeric membrane having a H₂S/CH₄ selectivity of at least 10 and CO₂/CH₄ selectivity of at least 5 at the pressure, temperature, and at a relative humidity of the natural gas feed stream; and
selectively permeating at least some of the CO₂ and the H₂S of the natural gas feed stream from the gas liquid separator through the polymeric membrane to produce a permeate stream having concentrated CO₂ and H₂S relative to the natural gas feed stream, and thereby producing a retentate stream that does not permeate through the polymeric membrane, and wherein the retentate stream has a higher concentration of CH₄ and a lower concentration of CO₂ and H₂S relative to the natural gas feed stream.

2. The process of claim 1, wherein the natural gas feed stream from the gas liquid separator has an H₂S content of 10 mol % or more and a relative humidity of 30% to 95%.

3. The process of claim 1, wherein the natural gas feed stream from the gas liquid separator has an H₂S content of between 5 mol % and 25 mol %.

4. The process of claim 1, wherein the temperature of the natural gas feed stream is between 30 C and 65 C, and the pressure of the natural gas feed stream is between 20 bar and 70 bar.

5. The process of claim 4, wherein the H₂S/CH₄ selectivity of the polymeric membrane is between 10 and 40 at the temperature and the pressure of the natural gas feed stream.

6. The process of claim 5, wherein the CO₂/CH₄ selectivity of the polymeric membrane is between 5 and 40 at the temperature and the pressure of the natural gas feed stream.

7. The process of claim 1, wherein the natural gas feed stream is not subjected to a dehydration process between the gas liquid separator and the membrane separation system.

8. The process of claim 1, wherein the polymeric membrane comprises a hollow-fiber type membrane, a spiral-wound membrane, or a combination thereof.

9. The process of claim 8, wherein the polymeric membrane is made of a cellulose triacetate (CTA) polymer, a cellulose acetate (CA) polymer, a polyamide-polyether block copolymer, polydimethylsiloxane (PDMS), a poly(ethylene oxide)-poly(butylene terephthalate) block copolymer, a polyimide, or any combination thereof.

10. The process of claim 1, comprising controlling the natural gas feed stream relative humidity to between 30% and 95% prior to introduction to the polymeric membrane using a temperature-controlled heater and a gas-liquid coalescer that removes 99% of droplets of 0.3 microns and higher.

11. The process of claim 1, comprising maintaining the pressure of natural gas feed stream into the polymeric membrane by controlling a backpressure on the retentate stream.

12. The process of claim 1, wherein the gas liquid separator is a slug catcher, 2-phase separator, or 3-phase separator.

13. A system for separating H₂S and CO₂ out of a natural gas feed stream, comprising:
a natural gas feed flow path extending from a gas liquid separator and to a membrane separation system, wherein the natural gas feed flow path is configured to feed the natural gas feed stream at a pressure of at least 20 bar, a temperature of at least 30° C., and a relative humidity of 30% to 95% to the membrane separation system;
a polymeric membrane of the membrane separation system, the polymeric membrane having a H₂S/CH₄ selectivity of at least 10 and CO₂/CH₄ selectivity of at least 5 at the pressure, the temperature, and the relative humidity of the natural gas feed stream; and
wherein the membrane separation system is configured to selectively permeate at least some of the CO₂ and the H₂S of the natural gas feed stream through the polymeric membrane to produce a permeate stream having concentrated CO₂ and H₂S relative to the natural gas feed stream, and thereby produce a retentate stream that does not permeate through the polymeric membrane, such that the retentate stream has a higher concentration of CH₄ and a lower concentration of CO₂ and H₂S relative to the natural gas feed stream.

14. The system of claim 13, wherein the H₂S/CH₄ selectivity of the polymeric membrane is between 10 and 40 and the CO₂/CH₄ selectivity of the polymeric membrane is between 5 and 40 at the temperature, the pressure, and the relative humidity of the natural gas feed stream.

15. The system of claim 13, wherein the natural gas feed flow path does not include a dehydration unit configured to dehydrate the natural gas feed.

16. The system of claim 13, wherein the polymeric membrane comprises a hollow-fiber type membrane, a spiral-wound membrane, or a combination thereof, and wherein the polymeric membrane is made of a cellulose triacetate (CTA) polymer, a cellulose acetate (CA) polymer, a polyamide-polyether block copolymer, polydimethylsiloxane (PDMS), a poly(ethylene oxide)-poly(butylene terephthalate) block copolymer, a polyimide, or any combination thereof.

17. The system of claim 13, comprising a temperature-controlled heater and a gas liquid coalescer positioned along the natural gas feed flow path and configured to control the natural gas feed relative humidity to between 30% and 95% prior to introduction to the polymeric membrane, and wherein the gas-liquid coalescer is configured to remove 99% of droplets of 0.3 microns and higher.
